(19) United States
(12) Patent Application Publication
(10) Pub. No.: US 2006/0020691 A1
(43) Pub. Date: Jan. 26, 2006

(54) Load balancing based on front-end utilization

(75) Inventors: Brian Patterson, Boise, ID (US); Charles Fuqua, Boise, ID (US); Guillermo Navarro, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/896,101

(22) Filed: Jul. 20, 2004

(51) Int. Cl. G06F 15/173

(52) U.S. Cl. 709/223

(57) ABSTRACT

A method of load balancing comprises actions of measuring utilization on an input/output interface, detecting a condition of utilization deficiency based on the measured utilization, and allocating utilization to cure the deficiency.

### BACKGROUND OF THE INVENTION

The evolution of information handling systems including systems for computing, communication, storage, and the like has involved a continual improvement in performance. One aspect of improvement is the steady increase in processing power. Other aspects are increased storage capacities, lower access times, improved memory architectures, caching, interleaving, and the like. Improvements in input/output interface performance enable mass storage capability with reasonable access speeds.

Various storage architectures, for example Redundant Arrays of Independent Disks (RAID) architectures, enable storage with improved performance and reliability than individual disks. A possible weakness in storage systems is the possibility of system bottleneck. A bottleneck is defined as a stage in a process that limits performance, for example a delay in data transmission that diminishes performance by slowing the rate of information flow in a system or network.

One type of bottleneck can result in the operation of a storage system that contains either multiple controllers or multiple arrays. Workload is typically distributed among multiple storage devices in a probabilistic manner. A condition can occur in which a particular subset of the controllers or arrays, or even a single controller or array, receives a predominant portion of the workload. In such a condition, little benefit is derived from the operation of other controllers or arrays in the system. The condition of concentrated workload, leading to bottleneck, is conventionally addressed only by system reconfiguration, a generally time-consuming operation that can devastate system availability.

### SUMMARY

In accordance with an embodiment of a method for operating a data handling system, a method of load balancing comprises actions of measuring utilization on an input/output interface, detecting a condition of utilization deficiency based on the measured utilization, and allocating utilization to cure the deficiency.

### BRIEF DESCRIPTION OF THE DRAWINGS

Embodiments of the invention relating to both structure and method of operation, may best be understood by referring to the following description and accompanying drawings.

FIG. 1 is a schematic block diagram illustrating an embodiment of a load balancing apparatus for usage in a data handling system.

FIG. 2 is a high-level schematic flow chart depicting an embodiment of a method for load balancing in a data handling system.

FIGS. 3A and 3B are schematic pictorial diagrams illustrating usage of a load balancing apparatus in a typical data handling environment.

FIG. 4 is a schematic block diagram that illustrates an embodiment of a data handing system with a load balancing capability.

FIG. 5 is a flow chart that depicts another embodiment of a technique for load balancing in a data handling system.

### DETAILED DESCRIPTION

A data handling system detects concentration of workload to a particular server device in a system that includes multiple server devices, and automatically corrects the workload concentration without user intervention.

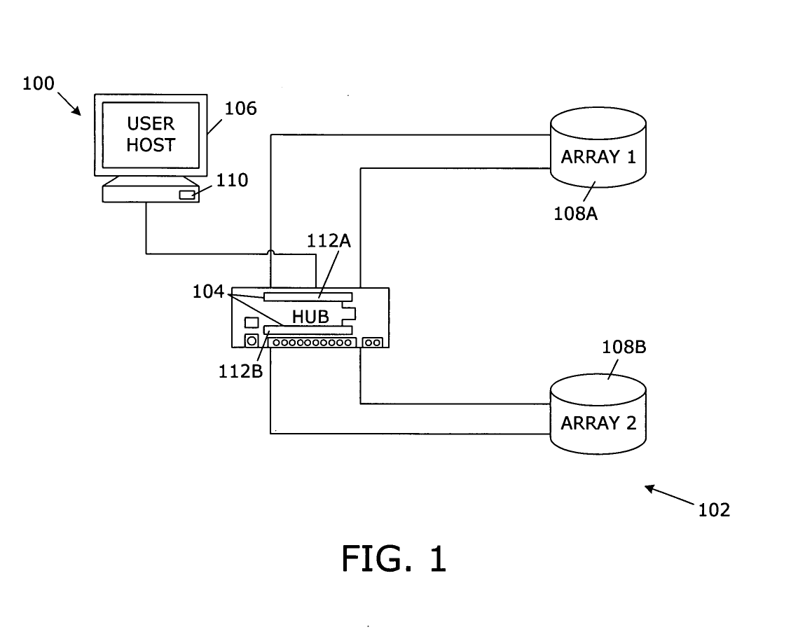

Referring to FIG. 1, a schematic block diagram illustrates an embodiment of a load balancing apparatus 100 for usage in a data handling system 102. The load balancing apparatus 100 comprises an input/output interface 104 in a client device 106 that is capable of communicating data between the client device 106 and multiple storage devices 108A, 108B that can function in a capacity as server devices performing services for a host. The load balancing apparatus further comprises a controller 110 coupled to the input/output interface 104 that can measure utilization on the input/output interface 104, detect a condition of utilization deficiency based on the measured utilization, and allocate utilization to cure the deficiency.

The input/output interface 104 in the client device 106 communicates data among a plurality of front-end ports 112A, 112B of a plurality of data handling devices, for example storage devices 108A, 108B. The controller 110 can measure utilization as the amount of activity on the plurality of front-end ports 112A, 112B including activity to specified target addresses in the multiple storage devices 108A, 108B.

The controller 110 can determine utilization by measurement of various parameters including one or more of total data transfer per unit time, total number of input/output operations per unit time, percentage of total bandwidth currently consumed, and input/output activity relative to average activity. For the selected measurement parameter or parameters, the controller 110 accumulates information regarding allocation of activity among target data subsets on the multiple storage devices 108A, 108B and detects utilization deficiency based on a divergent allocation of activity among the target subsets. If activity allocation diverges by more than a selected level, the controller 110 performs an action to mitigate the utilization deficiency.

In one technique for mitigating the utilization deficiency, the controller 110 modifies the utilization pathway from the client device 106 to target data subsets on the multiple storage devices 108A, 108B.

Alternatively, the controller 110 can mitigate utilization deficiency by migrating data from higher activity server devices to lower activity server devices of the multiple storage devices 108A, 108B.

Data migration on the storage devices 108A, 108B does consume some system resources including bandwidth and typically buffer storage. However, information monitored by the controller 110 can be used to facilitate efficient resource usage during data migration. The controller 110 can monitor utilization before and during data migration, and manage data migration to occur during conditions of relatively low utilization.

In various embodiments, the controller 110 can be implemented in any suitable device, such as a host computer, a hub, a router, a bridge, a network management device, and the like.

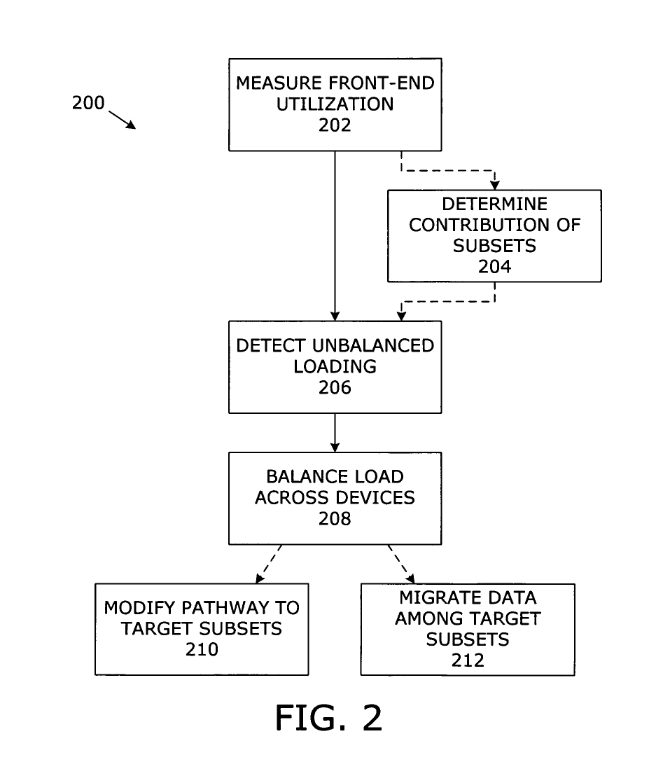

Referring to FIG. 2, a high-level schematic flow chart depicts an embodiment of a method for load balancing 200 in a data handling system. Basis for the technique is a measurement of front-end utilization 202 among one or more devices in the data handling system. In the described application, front-end and back-end are terms used to characterize program interfaces and services relative to one or more clients, or initial users of the interfaces and services. The terms front-end and back-end are used in reference to whatever component is acting in a server role. In the example illustrated in FIG. 1, the “front-end” relates to a host or interface such as a router, bridge, or other type of client device 106. In some examples, the client device 106 can be a storage controller. If the storage device 108A, 108B is acting as the server, for example to a user host operating as the client 106, then the front end includes connections from the host as the client device 106 to the storage device 108A, 108B as the server. The back-end includes connections from the storage device 108A, 108B to the disks behind the server. A front-end device is defined by a capability for direct interaction with a user or host. In contrast, a “back-end” application or device serves indirectly in support of the front-end services, usually by closer proximity to an ultimate resource or by possibly communicating or interacting directly with the resource. The resource can function as a storage device 108A, 108B. As part of analysis of front-end utilization, multiple target data subsets can be monitored to determine contribution 204 among the target data subsets to utilization demand among the devices.

Referring again to FIG. 2, the method 200 further includes the action of detecting 206 unbalanced loads, if any exist, across the plurality of devices based on the measured front-end utilization. Upon detection of an unbalanced load, utilization is balanced 208 across the plurality of devices. One or more balancing techniques may be implemented, for example, a pathway for accessing target data subsets on the devices can be modified 210, and/or data can be migrated 212 among target data subsets on the devices.

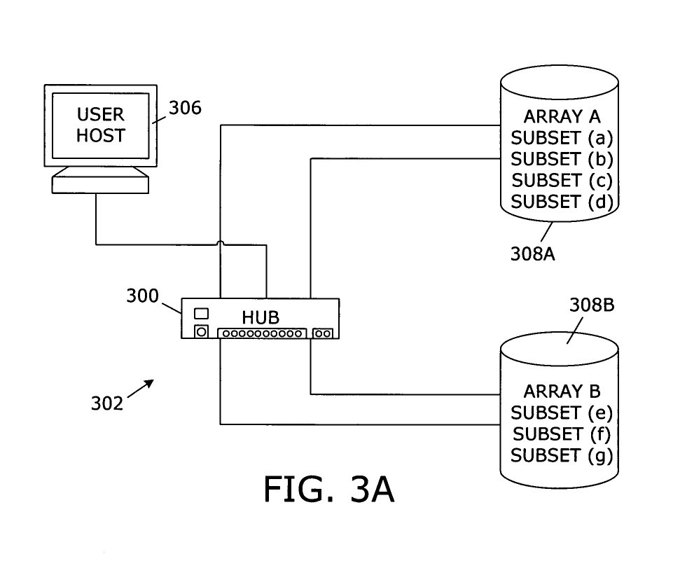

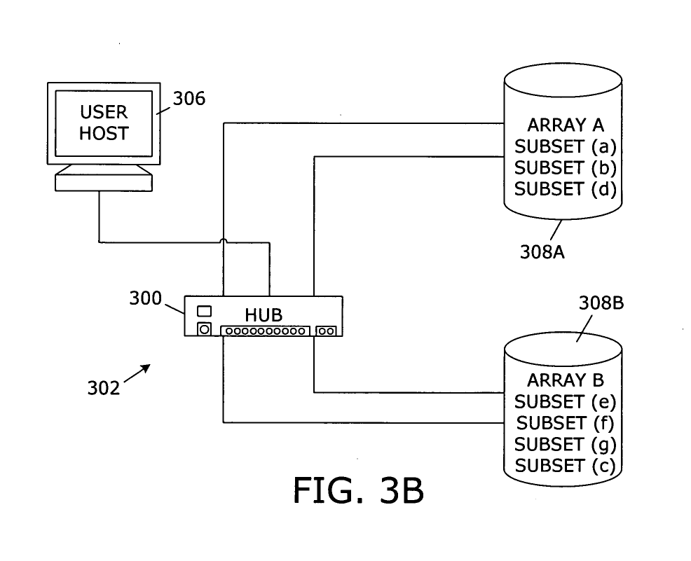

Referring to FIGS. 3A and 3B, two schematic pictorial diagrams illustrate usage of a load balancing apparatus 300 in a typical data handling environment. In an illustrative situation, two arrays 308A, 308B are included in a system 302. Within each array 308A, 308B, data is shown separated into three or four subsets for illustrative purposes and to facilitate discussion. In actual implementation and usage, the number of subsets in typically substantially higher. In one illustrative example, conditions of a particular workload may direct all work in the system 302 to subsets (b) and (c) on a first array A 308A, a situation in which performance experienced by the system 302 is no better than for a system that includes only a single array. Accordingly, array A 308A is operating as a bottleneck and the system 302 derives no benefit from the array B 308B. A bottleneck can be defined as a condition in which a particular device, for example an array or controller, has substantially higher utilization than the system average.

The load balancing apparatus 300, for example implemented in a client device such as the host computer 306, can track data on the utilizations taking place by each data subset and analyze the tracked data. Using the illustrative technique, the load balancing apparatus 300 detects the condition that all work is directed to subsets (b) and (c) and initiates a response to mitigate the condition. In a typical configuration, neither of the arrays 308A or 308B is capable of referring to data in the other array 308B, 308A, respectively. As a result, the host 306 initiates a mitigation action in which the host 306 reads a selected one of the high utilization data subsets, either subset (b) or subset (c), from array A 308A and rewrites the selected subset to array B 308B. As illustrated, for example according to arbitrary selection, subset (c) is selected for migration. Subset (c) is read from array A 308A and written to array B 308B as shown in FIG. 3B. Once data subset (c) is in residence on array B 308B, assuming the workload on subsets (b) and (c) remain the same or similar, proportionately less of the total workload is directed to array A 308A while the remaining workload is now directed to array B 308B. Utilization on each array 308A, 308B becomes proportionately more equal than the workload distribution on the arrays 308A, 308B prior to data subset (c) migration. Mitigation of the bottleneck on array A 308A and reduced interference between data transfers to data subsets (b) and (c), result in improved performance.

In the illustrative example, selection of subset (c) for migration is an arbitrary selection. In typical implementations, data subsets can be selected for migration in a manner that creates and preserves an optimum load balancing, for example assuming the proportional workload of the subsets remains the same.

In a hypothetical example of a system with ten arrays, detection of a bottleneck condition can evoke a response in which a client or host selects and moves the highest workload data subset from the bottlenecked array to a lowest workload array. Optionally, the client or host may further select and move the highest workload data subset remaining on the bottlenecked array to the array that is currently lowest workload after moving the first, initially highest workload, array. The process can continue until all arrays are maximally load balanced.

In other circumstances, more than one bottleneck may occur in a system. For example, two or more arrays or controllers may be bottlenecked in a system. The illustrative technique described hereinabove of a two-array system remains applicable and is further extended so that the host can monitor more than a single array to determine utilization. In some configurations and arrangements, more than one type of entity may be monitored, for example arrays and switch traffic. Another capability is traffic management when more than one array is bottlenecked, for example in a system of ten arrays where all activity is going to four of the arrays.

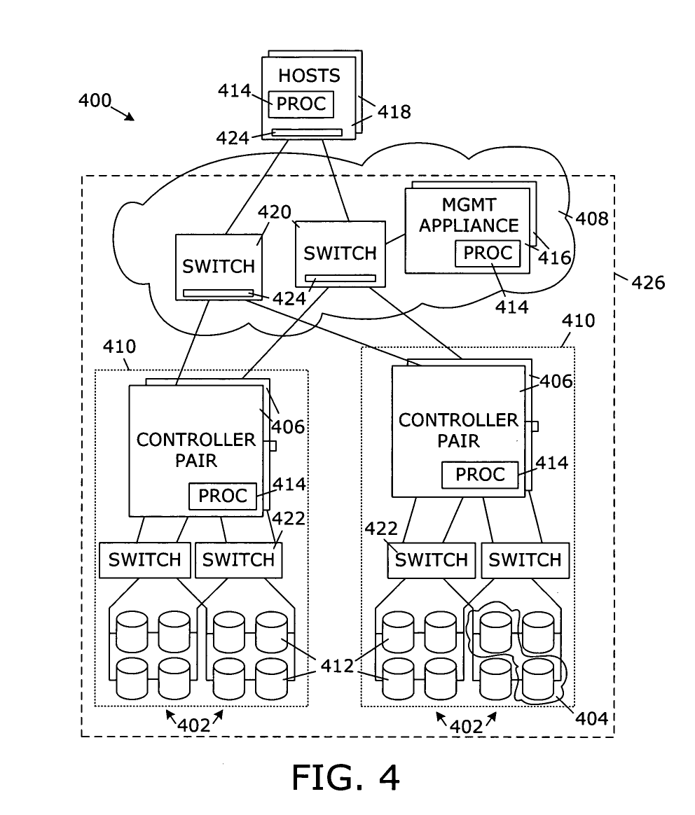

Referring to FIG. 4, a schematic block diagram illustrates an embodiment of a data handing system 400 with a load balancing capability. The data handling system 400 includes at least one client device 416, 418, 420 and a plurality of server devices 402 communicatively coupled to the client devices 418. The server devices 402 can serve a plurality of client devices 416, 418, 420. The data handling system 400 further includes an input/output interface 424 in a client device of the client devices 416, 418, 420. The input/output interface 424, for example a communications port, can communicate data between the client device and multiple server devices 402. The data handling system 400 also has a processor or controller 414 coupled to the input/output interface 424 that is capable of measuring utilization on the input/output interface 424, detecting a condition of utilization deficiency based on the measured utilization, and allocating utilization to cure the deficiency.

The data handling system 400 uses client or “front-end” utilization to detect unbalanced loads across server devices, for example storage arrays 402 and storage controllers 406. Upon detection of an unbalanced load, the data handling system 400 mitigates the unbalanced condition, for example by accessing the data via an alternative pathway—a different array 402 or controller 406. If another pathway is not available, the data handling system 400 can mitigate the unbalanced condition by migrating selected data subsets on the server device, for example array 402 or controller 406, which is experiencing the bottleneck to another server device. The data handling system 400 can select data subsets for migration based on a determination of the utilization demands imposed by the particular data subsets on the particular arrays 402 or controllers 406, and inference or prediction of the data subsets after migration. Utilization demands for the individual data subsets can be maintained on a client device, for example a host system 418, and forms a basis upon which subsets are selected for migration.

The illustrative data handling system 400 is shown in the form of a storage system. In alternative embodiments and configurations, the data handling system and operating method can be extended to any suitable type of server/client system including other types of storage systems, or in systems not involved in data storage, such as communication or computing systems, and the like. The data handling system and technique can be used in any suitable system in which parallel access of individual systems may lead to unbalanced load, and that the load is capable of migration from one individual system or another.

The client devices 416, 418, 420 can be configured in various systems 400 as computer systems, workstations, host computers, network management devices, switches, bridges, personal digital assistants, cellular telephones, and any other appropriate device with a computing capability. In various configurations, the server devices 402 can be storage arrays, storage controllers, communication hubs, routers, and switches, and the like.

The data handling system 400 has a capability to allocate resource management and includes a plurality of storage arrays 402 that are configurable into a plurality of storage device groups 404 and a plurality of storage controllers 406 selectively coupled to the individual storage arrays 402. A device group 404 is a logical construct representing a collection of logically defined storage devices having an ownership attribute that can be atomically migrated. The data handling system 400 can be connected into a network fabric 408 arranged as a linkage of multiple sets 410 of associated controllers 406 and storage devices 412. The individual sets 410 of associated controller pairs and storage shelves have a bandwidth adequate for accessing all storage arrays 402 in the set 410 with the bandwidth between sets being limited.

The data handling system 400 further includes processors 414 that can associate the plurality of storage device groups 404 among controllers 406 based on a performance demand distribution based on controller processor utilization of the individual storage device groups 404.

In various embodiments and conditions, the processors 414 utilized for storage management may reside in various devices such as the controllers 406, management appliances 416, and host computers 418 that interact with the data handling system 400. The data handling system 400 can include other control elements such as lower network switches 422. Hosts 418 can communicate with one or more storage vaults 426 that contain the storage arrays 402, controllers 406, and some of the components within the network fabric 408.

Deployment of LUNs across arrays can be managed in a data path agent above the arrays, for example in the intelligent switches 420 in the network fabric 408. LUNs can be deployed across arrays by routing commands to the appropriate LUNs and by LUN striping. Striping is a technique used in Redundant Array of Independent Disks (RAID) configurations to partition storage space of each drive. Stripes of all drives are interleaved and addressed in order. LUN deployment across arrays can be managed by striping level N LUNs across level N+1 LUNs, for example. Each LUN can contribute to utilization bottleneck. The illustrative technique can be used to change the striping of a LUN in response to a bottleneck, thereby migrating the bottlenecked LUN to a different striping and applying resources of multiple arrays to one host level LUN.

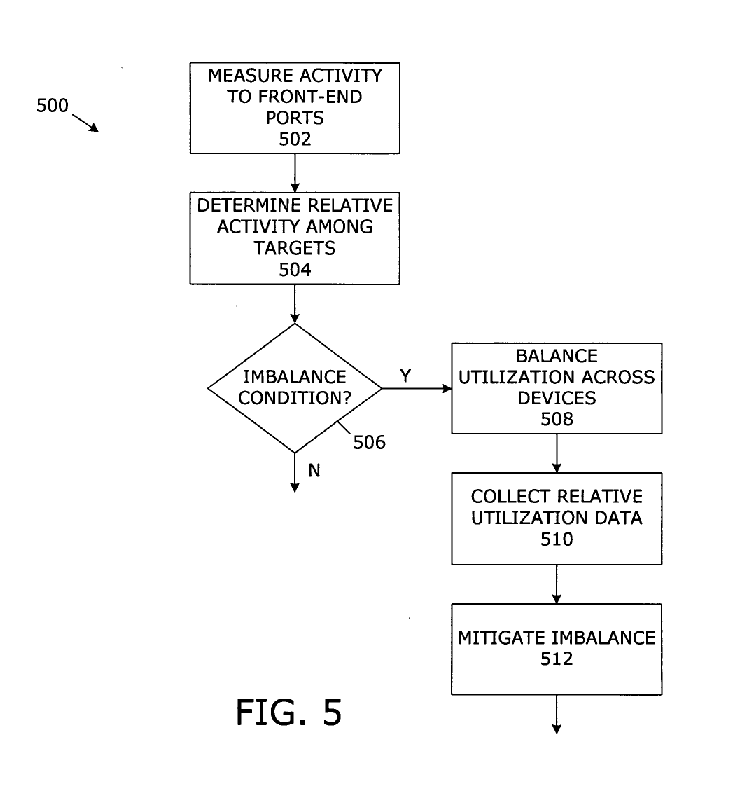

Referring to FIG. 5, a flow chart depicts another embodiment of a technique for load balancing 500 in a data handling system. The method includes the action of measuring activity 502 directed to front-end ports of a plurality of storage arrays or storage controllers. A data handling system measures activity to detect a bottleneck condition indicative of a substantial imbalance in workload across the storage arrays or controllers. Work can enter an array or controller via a limited number of pathways. For example, a particular array has a fixed number of front-end ports. Therefore, any work entering the array is constrained to enter through one of the ports, implying a relationship between the activity level on the front-end ports and activity level of the array. The relationship can be used to detect a bottleneck condition.

The method further includes the action of determining 504 whether activity of one storage array or storage controller, or a subset of storage arrays or controllers, is substantially higher than average activity of remaining storage arrays or storage controllers. If the amount of activity passing to the front-end ports of one array or controller is substantially higher than the average amount of activity passing to the front-end ports of the other arrays or controllers under consideration, then the first array, by implication, is substantially busier than the average. An array that is substantially busier than average suggests that an array or controller has become a system bottleneck.

The front-end activity of an array or controller is composed of operations communicating with a client, for example a host computer. Therefore, the client has full access to information relating to activity of the individual front-end ports and the target addresses of the activity. A measurement of front-end port utilization can be obtained from acquisition of various parameters including total data transfer per unit time, total number of input/output operations per unit time, percentage of total port bandwidth that is currently consumed, amount of input/output activity relative to an average activity, and others. A suitable parameter accurately indicates a gauge of the resource demands of an individual port relative to the average with respect to all ports.

An imbalance condition is designated 506 in the event of substantially dissimilar activity measurements. Regardless of the method of performing a utilization measurement and the measured parameter, the data handling system responds to the imbalance condition by balancing utilization 508 across the plurality of storage arrays or storage controllers.

Utilization is balanced 508 based on data collected 510 using a particular utilization measurement technique or parameter. Data is collected 510 to determine the amount of utilization that is applied to individual data subsets stored on the individual arrays or controllers. In one example, a data storage system configured for logical storage, utilization for individual logical units (LUNs) can be monitored and maintained or accumulated on a host computer. The accumulated information relates to allocation of activity among target data subsets on the front-end ports of multiple storage arrays or storage controllers. Individual utilization data are maintained in subsets that are sized so that no subset is so large that the utilization of the largest subset, taken alone, creates a system bottleneck. Utilization deficiency is detected based on divergent allocation of activity among the target data subsets. Accordingly, when a bottleneck is detected for an individual array or controller, the subsets that most contribute to the bottleneck can be determined. Once the contributing subsets are determined, load balancing is started 512.

One technique for mitigating utilization deficiency in some types of bottlenecked controllers is performed by modifying a utilization pathway to the target data subsets. For example, a data handling system mitigates a bottlenecked controller by accessing selected contributing subsets via a different controller. The different controller pathway mitigates the bottleneck by spreading the workload among a plurality of controllers. In some embodiments, utilization can be balanced by modifying a pathway for accessing target data subsets on multiple devices.

However, some types of arrays do not support modification of the utilization pathway. Similarly, individual arrays rarely support pathway modification.

Another technique for mitigating utilization deficiency is performed by migrating data from higher activity target data subsets to lower activity target data subsets. The more general solution to the bottlenecked array or controller is to migrate data from selected contributing subsets from the bottlenecked array or controller, and move the data onto another, more inactive array or controller. Accordingly, some of the data subsets that create the bottleneck condition in the controller or array are moved to other arrays or controllers. Assuming that the busy data subsets remain busy as the data is migrated, the workload that is creating the bottleneck is also migrated. Accordingly, once the migration is complete, the bottleneck is eased.

However, as the migration is occurring, activity on the system may increase if not properly managed. If the migration occurs at an arbitrary time, workload spikes can result as migration activity competes with user workload. To avoid or alleviate such workload spiking, the host can wait for periods of lower user activity to enable the migration process. If user activity again increases during migration, the host can suspend the migration activity until the user activity again diminishes.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, components, and dimensions can be varied to achieve the desired structure as well as modifications, which are within the scope of the claims. The illustrative usage and optimization examples described herein are not intended to limit application of the claimed actions and elements. For example, the illustrative task management techniques may be implemented in any types of storage systems that are appropriate for such techniques, including any appropriate media. Similarly, the illustrative techniques may be implemented in any appropriate storage system architecture. The task management techniques may further be implemented in devices other than storage systems including computer systems, data processors, application-specific controllers, communication systems, and the like.

What is claimed is:

1. A load balancing apparatus for usage in a data handling system comprising:
an input/output interface in a client device that is capable of communicating data between the client device and multiple server devices; and
a controller coupled to the input/output interface that measures utilization on the input/output interface, detects a condition of utilization deficiency based on the measured utilization, and allocates utilization to cure the deficiency.

2. The load balancing apparatus according to claim 1 further comprising:
the input/output interface in the client device that communicates data among a plurality of front-end ports of a plurality of data handling devices; and
the controller that measures utilization as the amount of activity on the plurality of front-end ports including activity to specified target addresses in the multiple server devices.

3. The load balancing apparatus according to claim 1 wherein the controller measures utilization as a measurement of total data transfer per unit.

4. The load balancing apparatus according to claim 1 wherein the controller measures utilization as a measurement of total number of input/output operations per unit time.

5. The load balancing apparatus according to claim 1 wherein the controller measures utilization as a measurement of percentage of total bandwidth currently consumed.

6. The load balancing apparatus according to claim 1 wherein the controller measures utilization as a measurement of input/output activity relative to an average activity.

7. The load balancing apparatus according to claim 1 further comprising:
the controller that accumulates information regarding allocation of activity among target data subsets on the multiple server devices, detects utilization deficiency based on divergent allocation of activity among the target subsets, and mitigates the utilization deficiency.

8. The load balancing apparatus according to claim 7 further comprising:
the controller that mitigates the utilization deficiency by modifying a utilization pathway from the client device to the target data subsets on the multiple server devices.

9. The load balancing apparatus according to claim 7 further comprising:
the controller that mitigates the utilization deficiency by migrating data from higher activity server devices to lower activity server devices of the multiple server devices.

10. The load balancing apparatus according to claim 9 further comprising:
the controller that monitors utilization before and during data migration, and managing data migration to occur during conditions of relatively low utilization.

11. A method for load balancing in a data handling system comprising:
measuring front-end utilization of a plurality of devices in the data handling system;
detecting unbalanced loads across the plurality of devices based on the measured front-end utilization;
upon detection of an unbalanced load, balancing utilization across the plurality of devices.

12. The method according to claim 11 further comprising:
balancing utilization by modifying a pathway for accessing target data subsets on the plurality of devices.

13. The method according to claim 11 further comprising:
balancing utilization by migrating data among target data subsets on the plurality of devices.

14. The method according to claim 13 further comprising:
determining contribution among the target data subsets to utilization demand among the plurality of devices.

15. A method for load balancing in a storage system comprising:
measuring activity directed to front-end ports of a plurality of storage arrays or storage controllers;
determining whether activity of one storage array or storage controller is substantially higher than average activity of remaining storage arrays or storage controllers and, if so, designating an imbalance condition; and
responding to an imbalance condition by balancing utilization across the plurality of storage arrays or storage controllers.

16. The method according to claim 15 further comprising:
balancing utilization by modifying a pathway for accessing target data subsets on the plurality of devices.

17. The method according to claim 15 wherein the action of measuring activity comprises measuring total data transfer per unit time.

18. The method according to claim 15 wherein the action of measuring activity comprises measuring total number of input/output operations per unit time.

19. The method according to claim 15 wherein the action of measuring activity comprises measuring percentage of total bandwidth currently consumed.

20. The method according to claim 15 wherein the action of measuring activity comprises measuring input/output activity relative to an average activity.

21. The method according to claim 15 further comprising:
accumulating information regarding allocation of activity among target data subsets on the front-end ports of a plurality of storage arrays or storage controllers;
detecting utilization deficiency based on divergent allocation of activity among the target subsets; and
mitigating the utilization deficiency.

22. The method according to claim 15 wherein mitigating the utilization deficiency further comprises:
modifying a utilization pathway to the target data subsets.

23. The method according to claim 15 wherein mitigating the utilization deficiency further comprises:
migrating data from higher activity target data subsets to lower activity target data subsets.

24. A method for load balancing in a data handling system comprising:
measuring utilization on an input/output interface;
detecting a condition of utilization deficiency based on the measured utilization; and
allocating utilization to cure the deficiency.

25. A data handling system comprising:
at least one client device;
a plurality of server devices communicatively coupled to the at least one client device and capable of serving a plurality of client devices;
an input/output interface in a client device of the at least one client device, the input/output interface being capable of communicating data between the client device and multiple server devices; and
a controller coupled to the input/output interface that is capable of measuring utilization on the input/output interface, detecting a condition of utilization deficiency based on the measured utilization, and allocating utilization to cure the deficiency.

26. The data handling system according to claim 25 wherein:
the at least one client device is a device selected from among a group of devices consisting of computer systems, workstations, host computers, and network management devices; and
the plurality of server devices are devices selected from among a group of devices consisting of storage arrays, storage controllers, communication hubs, routers, and switches.

27. The data handling system according to claim 25 further comprising:
the input/output interface in the client device that communicates data among a plurality of front-end ports of a plurality of data handling devices; and
the controller that measures utilization as the amount of activity on the plurality of front-end ports including activity to specified target addresses in the multiple server devices.

28. The data handling system according to claim 25 wherein the controller measures utilization using a measurement of total data transfer per unit time.

29. The data handling system according to claim 25 wherein the controller measures utilization using a measurement of total number of input/output operations per unit time.

30. The data handling system according to claim 25 wherein the controller measures utilization using a measurement of percentage of total bandwidth currently consumed.

31. The data handling system according to claim 25 wherein the controller measures utilization using a measurement of input/output activity relative to an average activity.

32. The data handling system according to claim 25 further comprising:
the controller that accumulates information regarding allocation of activity among target data subsets on the multiple server devices, detects utilization deficiency based on divergent allocation of activity among the target subsets, and mitigates the utilization deficiency.

33. The data handling system according to claim 32 further comprising:
the controller that mitigates the utilization deficiency by modifying a utilization pathway from the client to the target data subsets on the multiple server devices.

34. The data handling system according to claim 32 further comprising:
the controller that mitigates the utilization deficiency by migrate data from higher activity server devices to lower activity server devices of the multiple server devices.

35. The data handling system according to claim 34 further comprising:
the controller that monitors utilization before and during data migration, and managing data migration to occur during conditions of relatively low utilization.
